(19) United States
(12) Patent Application Publication
(10) Pub. No.: US 2005/0190772 A1
(43) Pub. Date: Sep. 1, 2005

(54) Method of triggering application service using filter criteria and IP multimedia subsystem using the same

(76) Inventors: Shang-Chih Tsai, Taichung City (TW); Wei-Kuo Chiang, Hsinchu City (TW); Chun-Min Chen, Hsinchu City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/787,610

(22) Filed: Feb. 26, 2004

(51) Int. Cl. H04L 12/28

(52) U.S. Cl. 370/395.52; 370/465

(57) ABSTRACT

A triggering method for IP multimedia service control. The triggering method comprises monitoring a session state or user state according to a set of specific filter criteria, recording a corresponding SIP request message, and triggering an application server designated by the criteria if a trigger point thereof matches the session state or user state. Furthermore, the SIP-server performs additional action effectively manage the session or services according to the Action defined in the user profile. The scheme is suited to application services triggered according to session state or user state, and is compatible with the iFC scheme defined in 3GPP. The present invention improves the efficiency of communication and enhances the flexibility of the SIP server.

### BACKGROUND OF THE INVENTION

1. Field of the Invention

The present invention relates to an IP multimedia subsystem, and more specifically, to an application triggering method of a 3GPP IP multimedia subsystem using specific filter criteria.

2. Description of the Related Art

FIG. 1 illustrates an example of the architecture of a 3GPP (Third Generation Partnership Project) IP (Internet Protocol) multimedia subsystem. The IP multimedia subsystem is divided into visited network 10, home network 11, and external network 12. As shown in the diagram, User Equipment (UE) 101 in the visited network connects to the General Packet Radio Service (GPRS) system 102 through a 3G/UMTS communication network. There is a Proxy Call Session Control Function (P-CSCF) 103 in the visited network for communication with an Interrogating CSCF 111 (I-CSCF) and a Serving CSCF (S-CSCF) 112 in the home network 11. The Home Subscriber Server (HSS) 113 stores subscriber-related information and service-related data for the S-CSCF 112, I-CSCF 111, and application servers 114. The service-related data is transparent to the HSS 113, thus the HSS 113 has some means to differentiate the source of the request for the data, so it is able to respond with the requested data. The Multimedia Resource Function (MRF) 115 comprises a Multimedia Resource Function Controller (MRFC) and Multimedia Resource Function Processor (MRFP). The application servers can interact with the MRFC via the S-CSCF to control Multimedia Resource Function (MRF) processing. The S-CSCF 112 communicates to the application servers 114 via the IP multimedia service control (ISC) interface. The application servers 114 can be Session Initiation Protocol (SIP) application servers, Open Service Access (OSA) service capability server (OSA SCS), and others. As shown in the diagram, the computer 121 and Voice over IP (VoIP) phone 122 in the external network 12 are connected to the rest of the IP multimedia subsystem via the Internet.

FIG. 2 illustrates an example of call forwarding on no-answer in the 3GPP IP multimedia subsystem. User B 201 in Home Network B 20 wishes to call user A 210 in Home Network A 21, so user B 201 sends an SIP request message to P-CSCF 202 to initiate the call. The P-CSCF 202 forwards the SIP request message to the S-CSCF 203 of Home Network B 20, then to the I-CSCF 214 and S-CSCF 213 of Home Network A 21. The ISC interface of the 3GPP IP Multimedia Subsystem (IMS) regulates Filter Criteria (FC) mechanism for the S-CSCF. FC defines the relevant Service Point Triggers (SPTs) for triggering each application. When the S-CSCF 213 receives the SIP request, it examines the request according to the SPTs of the FC, in order to determine where to send/proxy the SIP message. The S-CSCF 213 retrieves relevant information such as the FC from the HSS 216. If the SPTs match the trigger points of the SIP message, the S-CSCF 213 sends an SIP trigger message to the application server (AS) 215. The SIP request originating from User B is then sent to User A 210 through the P-CSCF 212 from the S-CSCF 213. After unanswered ringing, the timer set in the AS 215 indicates time-out, and the AS 215 cancels the request sent to User A 210. The AS 215 provides the service of call forwarding, thus the AS 215 generates a request to invite User A Home 211.

The standard FC defined by 3GPP performs filtering according to the initial SIP request messages only, refered to as initial Filter Criteria (iFC). FIG. 3 illustrates the triggering mechanism for IP multimedia service control using the iFC. The S-CSF 31 applies iFC to determine a need to forward SIP requests to corresponding application servers when a user sends an SIP initial request. The iFC are stored in the HSS 33 as part of the user profile and downloaded to the S-CSCF 31 upon user registration, or upon a terminating initial request for an unregistered user if unavailable. The iFC represent a provisioned subscription of a user to an application. The iFC are valid throughout the registration lifetime of a user or until the user profile is changed.

The S-CSCF 31 first requests the relevant set of iFCs from the HSS 33 that applies to the end user. When the S-CSCF 31 receives the SIP initial request, it determines whether the SIP request matches iFC X according to the SPTs. The SIP request is forwarded to the first application server (AS1) 32 if it matches the iFC X. The SIP interface 321 receives the SIP request and executes the relevant service logic 322 according to the service key. The service logic 322 of the AS1 32 may modify the SIP request, and then the SIP message is returned to the S-CSCF 31. The S-CSCF 31 also determines if the SPTs matches the iFC Y, and if so, the SIP request is sent to the second application server (AS2) 34. Similarly, the AS2 34 receives the SIP request from the SIP interface 341, and executes the service logic 342 within AS2 34. If no more (or none) of the iFC apply, the S-CSCF 31 forwards this SIP request downstream based on the route decision. In any instance, if contact with the application server fails, the S-CSCF 31 uses the “default handling” associated with the iFC to determine whether to terminate the call or continue based on the information in the FC.

The 3GPP standard only defines the initial Filter Criteria (iFC) triggering mechanism triggered by the SIP request, whereby all the service calls need to be forwarded to the application servers in order to handle the service correctly. In certain situations, the decision to trigger the application servers cannot be determined by the SIP request message, forwarding of which to the application servers thereby wastes the resources and increases application server loading. The triggering procedure thus becomes very complicated and results in increased run time delay and traffic in the servers.

### SUMMARY OF THE INVENTION

Accordingly, the object of the present invention is to reduce the number of unnecessary SIP message relays, in order to improve the efficiency of establishing session calls.

Another object of the present invention is to simplify the operational configuration of the application servers from back-to-back user agent (UA) to terminating UA.

Yet another object of the present invention is to provide a flexible multimedia service control capability to the S-CSCF.

To achieve these objects, the present invention provides a triggering method for IP multimedia service control using state Filter Criteria (stFC), definition of which follows.

State Filter Criteria defines specific user states and session states for triggering each application service provided by the service provider. For example, voice mail service is triggered when the user state is determined as busy. The triggering method disclosed in the present invention comprises monitoring a user state or session state of a session or service initiated by a Session Initial Protocol (SIP) request message received by an SIP server according to a set of state Filter Criteria (stFC), and triggering an application server (AS) designated by the stFC if a trigger point of the stFC matches the session state. The session state and user state are known by the SIP server from observation of the flow of the SIP messages, and the user state can be set by the user or the user equipment. The SIP server records the SIP request message for the use of triggering AS or performing extra services. The SIP server performs additional action to handle the session or service at the point of triggering according to an action specified in the stFC. The action can be “terminating current outgoing leg”, “holding current outgoing leg”, “setting timer”, “informing AS”, or “running script”, etc. The SIP server is the S-CSCF of the peer user's home network. Examples of the session state are initial, ringing, no-answer, busy, error, peer user unreachable, cancel by peer user, and re-invite, and examples of the user state are registered/unregistered, online/offline, busy, away, and meeting.

The stFC is compatible with 3GPP standard, which improves the efficiency of the IP multimedia subsystem. The S-CSCF becomes more flexible as the application servers are triggered not only according to the initial SIP message/request, but also the session state and user state. The HSS and S-CSCF of the IP multimedia subsystem can be easily modified to support the stFC. The HSS requires storage of stFC-related information in the user profile and the S-CSCF requires the ability to process the stFC information. Any application server or HSS not supporting the stFC remains unchanged in the subsystem. The storage location, data format, download timing, and matching manner of the stFC are identical to the iFC defined in the 3GPP IP Multimedia Subsystem (IMS) IP multimedia Service Control (ISC). The stFC are stored in a HSS as part of the user profile, and downloaded to the S-CSCF upon user registration.

The present invention also provides an IP multimedia subsystem to perform the triggering method described above, wherein the IP multimedia subsystem comprises at least one S-CSCF, at least one application server, and a HSS. The application server can be an SIP application server, Internet Protocol (IP) Multimedia Service Switching Function (IP-SSF), or Open Service Access (OSA) Service Capability Server (SCS). The S-CSCF checks the session state or user state and triggers an application server designated by the stFC if the session state/user state matches the trigger point defined in the stFC.

### BRIEF DESCRIPTION OF THE DRAWINGS

The present invention can be more fully understood by reading the subsequent detailed description in conjunction with the examples and references made to the accompanying drawings, wherein:

FIG. 1 illustrates the network configuration of the 3GPP IP multimedia subsystem;

FIG. 2 illustrates an example of call forwarding responding to no-answer in the 3GPP IP multimedia subsystem service structure;

FIG. 3 illustrates the application triggering architecture according to the initial Filter Criteria (iFC) scheme;

FIG. 4a is a SIP message flow diagram showing call forwarding responding to no-answer using the conventional iFC scheme;

FIG. 4b is a SIP message flow diagram showing call forwarding responding to no-answer using the stFC scheme according to the present invention;

FIG. 5a illustrates the UML model of a user profile stored in the HSS;

FIG. 5b illustrates the UML model of a service profile in the user profile;

FIG. 5c illustrates the UML model of a state Filter Criteria in the service profile;

FIG. 5d illustrates the UML model of a service point of trigger in the state Filter Criteria.

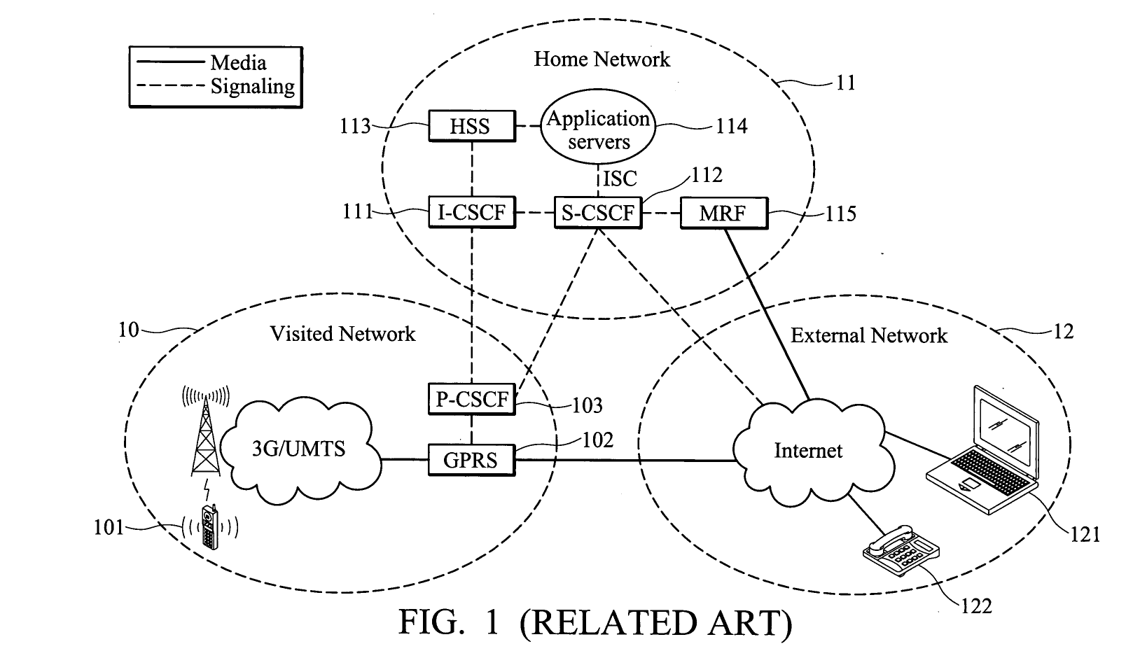

### DETAILED DESCRIPTION OF THE INVENTION

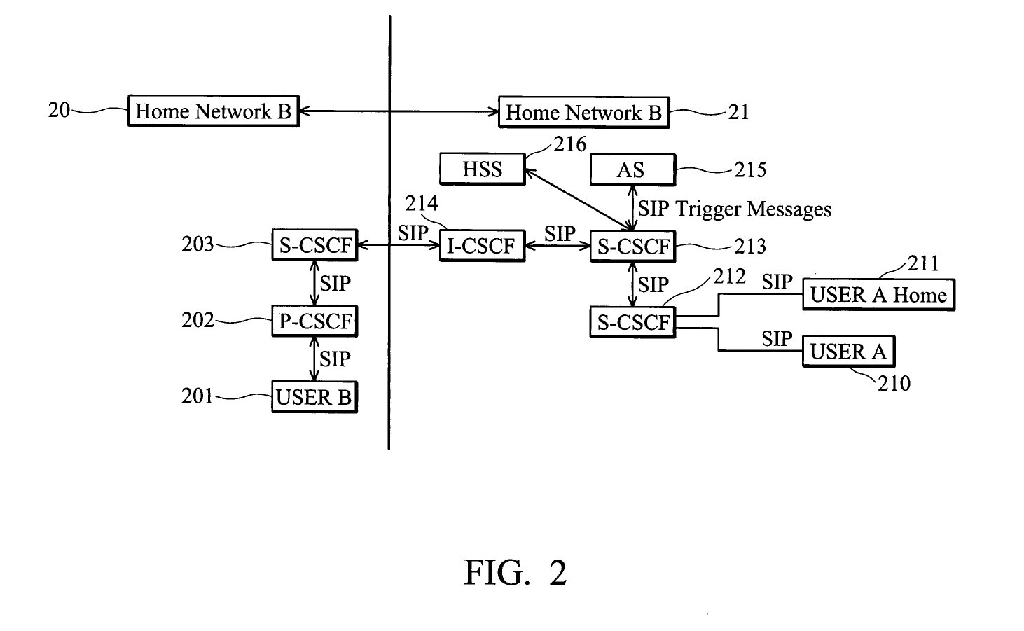

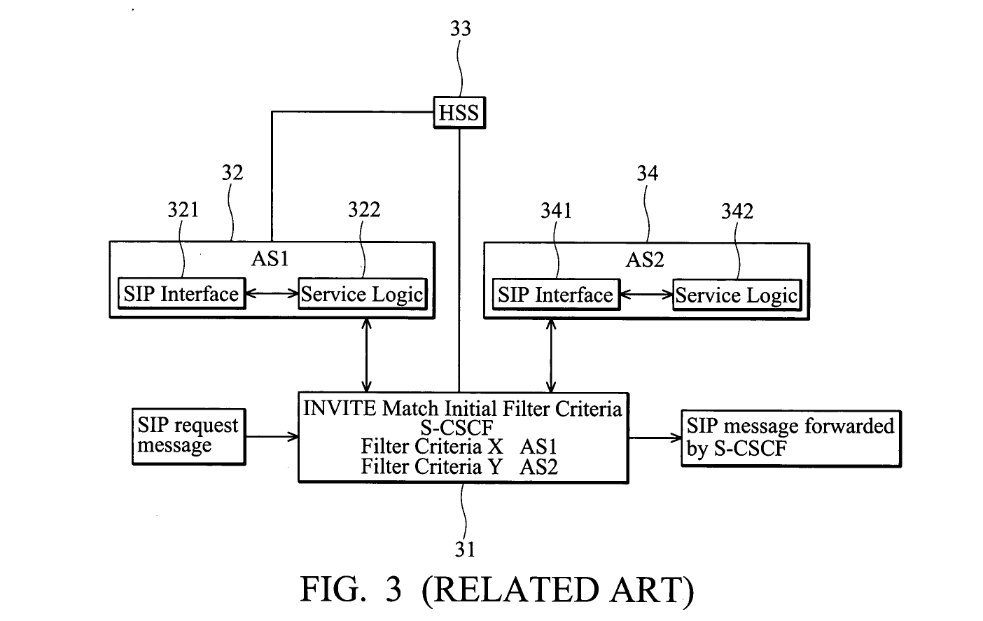

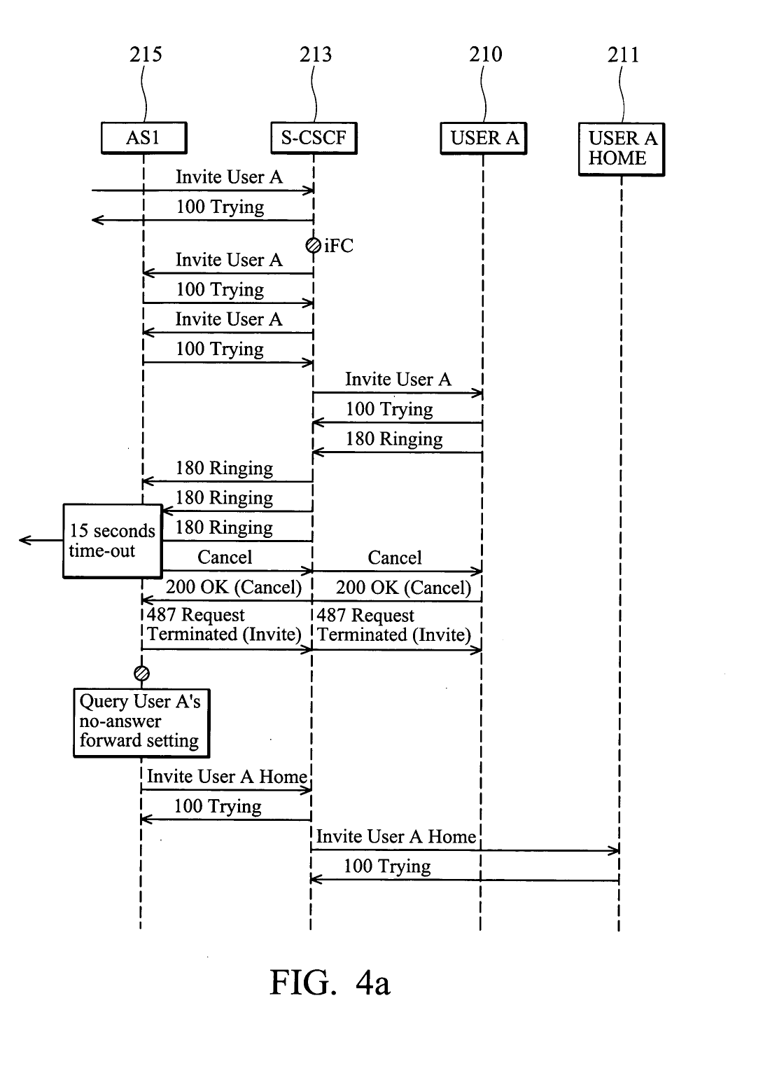

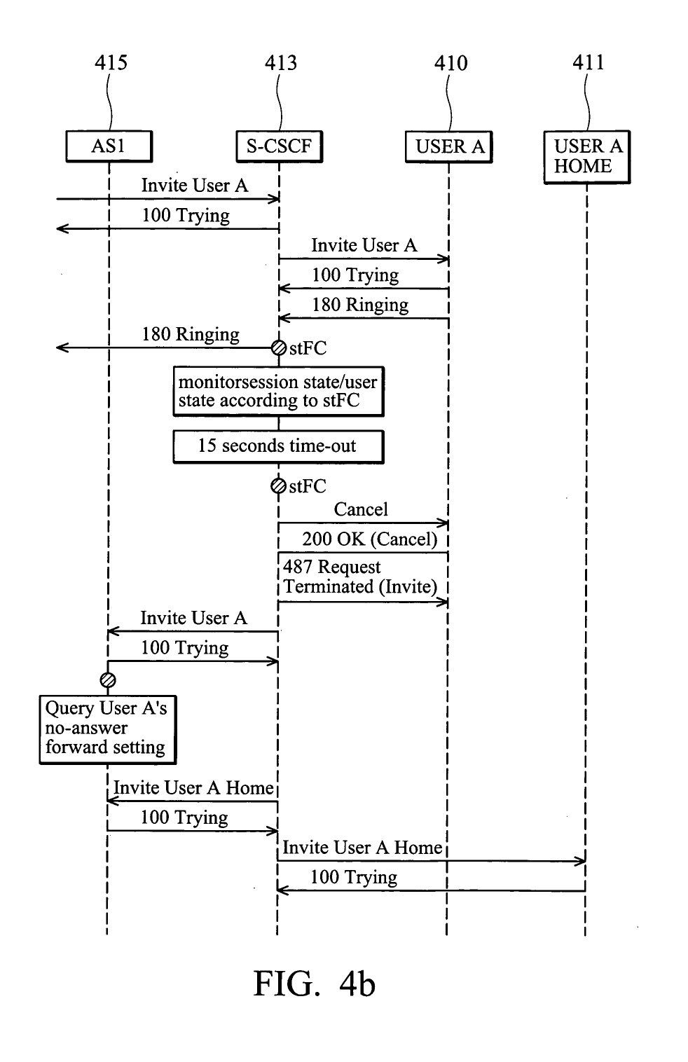

FIGS. 4a and 4b illustrate the SIP message flow sequence in the case of call forwarding to User A home when User A is busy, the same example shown in FIG. 2. FIG. 4a shows the SIP message flow in the IP multimedia subsystem only using the iFC scheme, whereas FIG. 4b shows the SIP message flow in the IP multimedia subsystem using the stFC scheme disclosed in the present invention.

As shown in FIG. 4a, a user B originates an SIP invitation message according to the standard 3GPP IMS to request call initiation with user A 210. The SIP invitation message passes to the S-CSCF 213 of user A's home network, and the S-CSCF 213 passes it to an application server (AS1) 215. AS1 215 is designated for call forwarding in response to no-answer, and is responsible for monitoring the state of user A 210. After 15 seconds of ringing, AS1 215 terminates the request to user A 210 and invites user A home 211. As shown in the diagram, all messages pass through AS1 215 and S-CSCF 213, which complicates the flow. Furthermore, the current state of User A 210 must be stored in both AS1 215 and S-CSCF 213, wasting channel resources. As shown in FIG. 4a, SIP message transmission between AS1 215 and S-CSCF 213 is frequent (11 SIP messages in this example) if the iFC is the only triggering method. By implementing the stFC of the present invention, traffic between S-CSCF 213 and AS1 215 is reduced significantly.

FIG. 4b illustrates the situation shown in FIG. 4a. Once the S-CSCF 413 receives the SIP invitation message, it forwards the message to user A 410 without going through AS1 415. After 15 seconds of ringing, the S-CSCF 413 triggers call forwarding in response to no-answer according to the session state of the call to user A 410, and send an SIP message to AS1 415 to implement forwarding. By implementing the stFC scheme of the present invention, AS1 415 avoids recording the state of user A 410. AS1 415 simplified, since no requirement of decision making is necessary since the S-CSCF 413 only forwards SIP messages requiring the particular service provided by AS1 415. In the example shown in FIG. 4b, the number of SIP messages transmitted between the S-CSCF 413 and AS1 415 is now reduced to 4.

In addition to the advantage of reduced message relay between the S-CSCF and AS when service is triggered, the present invention also avoids unnecessary message communication between the S-CSCF and AS when the service is not triggered. SIP message traffic to the application servers is also reduced significantly, improving overall the efficiency of the IP multimedia subsystem. Application server loading is greatly reduced in the present invention, with no requirement for message determination and transfer (back-to-back service) these duties now being performed in the SIP server.

The triggering method is especially suitable for application services triggered according to the session state or user state. Some examples of application services are no-answer forwarding, voice mail, caller filter, third party call control, and free number service. The application servers execute these application services when they receive a trigger message from an SIP server (for example, S-CSCF). In the present invention, the SIP server continuously monitors the session state and user state in order to control the SIP session. The SIP server downloads the state Filter Criteria (stFC) set in the user profile from the HSS, and sends a triggering message to a corresponding application server if the trigger point matches the session state or user state of the proceeding SIP session. The trigger message can be either an SIP message or self-defined message.

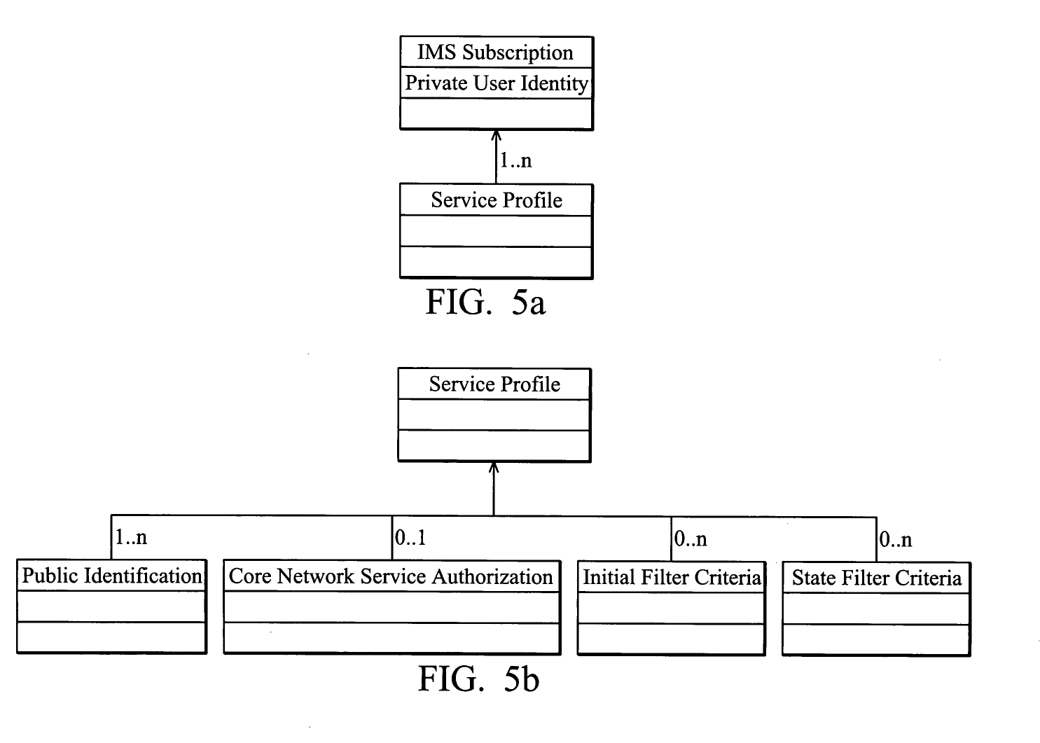

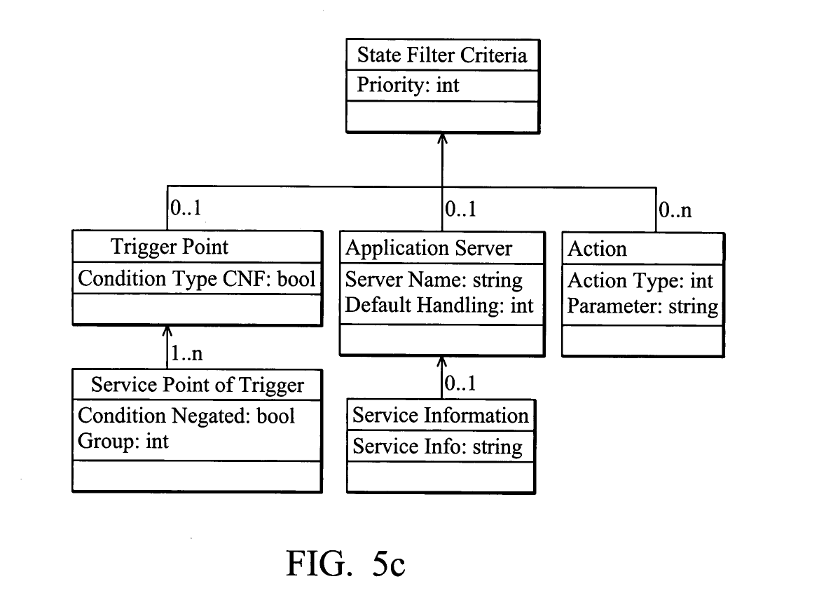

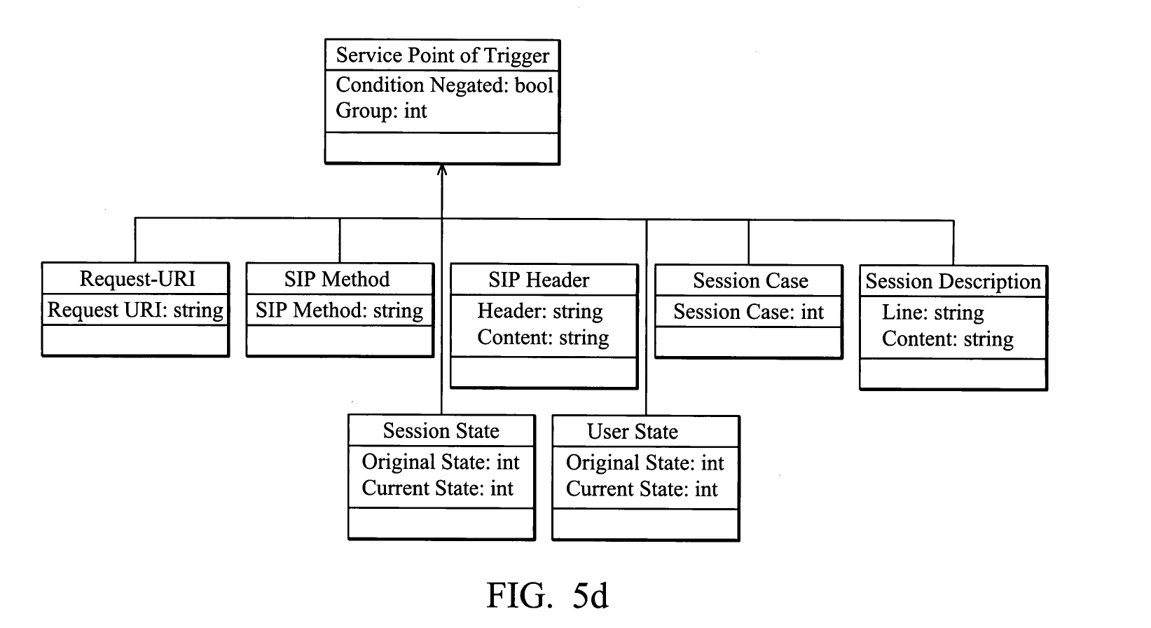

The S-CSCF downloads the stFC from the HSS over the Cx Interface (3GPP 29.228), and the user profile included the stFC is described using the UML model shown in FIGS. 5a, 5b, 5c, and 5d. The UML model defines an abstract level of the structure, and different information classes included in the user profile. As shown in FIG. 5a, the IMS Subscription class contains as a parameter the private user identity of the user in NAI format, and each instance of the IMS Subscription class contains one or several instances of the class Service Profile. FIG. 5b shows an outline of the UML model of the Service Profile class, each instance of the Service Profile class comprising one or several instances of class Public Identification, wherein Public Identification class comprises the public identities of the user associated with the service profile. If no instance of the class Core Network Service Authorization is present, no filtering related to subscribed media applies in S-CSCF. Each instance of the class Service Profile contains zero or several instances of the class Initial Filter Criteria and the class State Filter Criteria. Apart from the State Filter Criteria class, all other classes are already present in the existing IP multimedia subsystem regulated by 3GPP.

FIG. 5c illustrates the UML model of the State Filter Criteria class provided by the present invention. The State Filter Criteria class has a similar outline to the Initial State Filter Criteria, the two classes being identical except that the State Filter Criteria class adds a new class Action, and modifies the Service Point of Trigger. The modified Service Point of Trigger is discussed later with the aid of FIG. 5d. Each instance of the State Filter Criteria class is composed of zero or one instance of a Trigger Point class and one instance of an Application Server class. Condition Type CNF is a Boolean TRUE when the Trigger Point associated with the Filter Criteria is a Boolean expression in Conjunctive Normal Form (CNF) and FALSE if the Trigger Point is expressed in Disjunctive Normal Form (DNF). Trigger Point class describes the trigger points to be checked to determine if the indicated Application Server is to be contacted or not. The absence of Trigger Point instance indicates an unconditional triggering to Application Server. The Service Information class included in the Application Server class allows downloading to S-CSCF information, and the Service Information is transferred transparently to an Application Server when the Trigger Points specified are satisfied. The Action class describes the actions the S-CSCF is to perform when the Trigger Points match, which includes two parameters: Action Type and Parameter. Action Type defines the nature of the action, for example, terminating the current outgoing leg, holding the current outgoing leg, setting a timer, informing the application server, running the script, etc. Parameter indicates the parameters required for executing the action. For example, the S-CSCF execute the script language specified in the Parameter if the Action Type is RUN_SCRIPT, or set a timer according to the time-out count specified in the Parameter if the Action Type is SET_TIMER. The stFC specifies the behavior of the S-CSCF to govern the SIP session and services according to the Action class.

FIG. 5d outlines the UML model of Service Point Trigger class modified according to the present invention. The Request-URI class, SIP Method class, SIP Header class, Session Case class, and Session Description class are identical to the content in the Service Point of Trigger of the Initial Filter Criteria. The Session State class and User State class defines the Service Point of Trigger (SPT) for particular session states and user states. Each two classes comprises two parameters: Original State and Current State, representing the Application Server is triggered when the Session State or User State changes from Original to Current. Note that both the Original State and Current State can be designated as “Any” or “Don't Care”, indicating that the original/current state for triggering is not limited. Possible SIP Session States are Initial, Ringing, No-Answer, Busy, Error, Peer user unreachable, Cancel by peer user, and Re-invite, etc. Possible user states are registered, unregistered, online, offline, busy, away, and meeting, or others.

Furthermore the SIP server records an SIP request message (or Initial Request) sent by the user when initiating the SIP session to trigger other application servers or execute other services.

The triggering method using stFC is compatible to the original triggering method proposed in the 3GPP standard, and the stFC improves the triggering mechanism by enhancing flexibility.

When implementing the triggering method of the present invention, the S-CSCF requires processing of stFC information in the user profile, and the HSS must store additional stFC information in the user profile, for download to the S-CSCF upon request. Application servers or HSS not supporting the stFC remain unchanged.

Finally, while the invention has been described by way of example and in terms of the above, it is to be understood that the invention is not limited to the disclosed embodiment. On the contrary, it is intended to cover various modifications and similar arrangements as would be apparent to those skilled in the art. Therefore, the scope of the appended claims should be accorded the broadest interpretation so as to encompass all such modifications and similar arrangements.

1. A triggering method for IP multimedia service control, comprising the steps of:
monitoring a session state of a session or service initiated by a Session Initial Protocol (SIP) request message received by an SIP server according to a set of state Filter Criteria (stFC), comprising specific user states and session states triggering individual application services available for a service provider; and
triggering an application server (AS) designated by the stFC if a trigger point of the stFC matches the session state of the session or service.

2. The triggering method according to claim 1, further comprising observing the session state from an SIP message flow.

3. The triggering method according to claim 1, further comprising specifying an action in the stFC for the SIP server to perform additional action to effectively manage the session or service.

4. The triggering method according to claim 3, wherein the action comprises terminating a current outgoing leg, holding a current outgoing leg, setting a timer, informing the AS, or running a script.

5. The triggering method according to claim 1, wherein the session state comprises either initial, ringing, no-answer, busy, error, peer user unreachable, cancel by peer user, or re-invite.

6. The triggering method according to claim 1, further comprising recording the SIP request message in the SIP server to trigger AS or perform additional services.

7. The triggering method according to claim 1, wherein the SIP server is a Serving Call Session Control Function (S-CSCF).

8. The triggering method according to claim 1, further comprising the steps of:
monitoring a user state according to the stFC; and
triggering an application server (AS) designated by the stFC if a trigger point of the stFC matches the user state.

9. The triggering method according to claim 8, further comprising observing the user state from an SIP message flow.

10. The triggering method according to claim 8, wherein the user state is set by a user.

11. The triggering method according to claim 8, wherein the user state comprises registered, unregistered, online, offline, busy, away, or meeting.

12. The triggering method according to claim 1, wherein the stFC are stored in a Home Subscriber Server (HSS) as part of a user profile.

13. The triggering method according to claim 1, wherein the stFC are downloaded to the SIP server upon user registration.

14. The triggering method according to claim 1, wherein the application server is an SIP application server.

15. The triggering method according to claim 1, wherein the application server is an Internet Protocol (IP) Multimedia Service Switching Function (IP-SSF).

16. The triggering method according to claim 1, wherein the application server is an Open Service Access (OSA) Service Capability Server (SCS).

17. The triggering method according to claim 1, wherein the triggering method is applied when the application server or requested service is triggered depending on a session state.

18. The triggering method according to claim 8, wherein the triggering method is applied when the application server or requested service is triggered depending on a user state.

19. A triggering method for IP multimedia service control, comprising the steps of:
monitoring a user state during a session or service initiated by a Session Initial Protocol (SIP) request message received by an SIP server according to a set of state Filter Criteria (stFC), comprising specific user states and session states triggering individual application services available for a service provider; and
triggering an application server (AS) designated by the stFC if a trigger point of the stFC matches the user state.

20. The triggering method according to claim 19, further comprising observing the user state from an SIP message flow.

21. The triggering method according to claim 19, wherein the user state is set by a user or a user equipment.

22. The triggering method according to claim 19, further comprising specifying an action in the stFC for the SIP server to perform additional action to effectively manage the session or service.

23. The triggering method according to claim 22, wherein the action comprises terminating a current outgoing leg, holding a current outgoing leg, setting a timer, informing the AS, or running a script.

24. The triggering method according to claim 19, further comprising recording the SIP request message in the SIP server to trigger AS or perform additional services.

25. The triggering method according to claim 19, wherein the SIP server comprises a Serving Call Session Control Function (S-CSCF).

26. The triggering method according to claim 19, wherein the user state comprises registered, unregistered, online, offline, busy, away, or meeting.

27. The triggering method according to claim 19, wherein the stFC are stored in a Home Subscriber Server (HSS) as part of the user profile.

28. The triggering method according to claim 19, wherein the stFC are downloaded to the SIP server upon user registration.

29. The triggering method according to claim 19, wherein the triggering method is applied when the application server or requested service is triggered depending on a user state.

30. An Internet Protocol (IP) multimedia subsystem, comprising:
at least one Session Initial Protocol (SIP) server, receiving an SIP request message to initiate a session, monitoring a session state/user state of the session according to a set of state Filter Criteria (stFC), comprising specific user states and session states triggering individual application services available for a service provider; and
at least one application server, receiving a trigger message from the SIP server if a trigger point of the stFC matches the session state/user state of the session.

31. The IP multimedia subsystem according to claim 30, wherein the SIP server performs additional actions according to an action specified in the stFC.

32. The IP multimedia subsystem according to claim 31, wherein the action comprises terminating a current outgoing leg, holding a current outgoing leg, setting a timer, informing the AS, or running a script.

33. The IP multimedia subsystem according to claim 30, wherein the session state comprises initial, ringing, no-answer, busy, error, peer user unreachable, cancel by peer user; or re-invite.

34. The IP multimedia subsystem according to claim 30, wherein the user state comprises registered, unregistered, online, offline, busy, away, or meeting.

35. The IP multimedia subsystem according to claim 30, wherein the SIP server records the SIP request message to trigger AS or perform additional services.

36. The IP multimedia subsystem according to claim 30, wherein the SIP server comprises a Serving Call Session Control Function (S-CSCF).

37. The IP multimedia subsystem according to claim 30, further comprising a Home Subscriber Server (HSS) storing the stFC as part of the user profile

38. The IP multimedia subsystem according to claim 30, wherein the SIP server downloads the stFC upon user registration.

39. The IP multimedia subsystem according to claim 30, wherein the application server is an SIP application server.

40. The IP multimedia subsystem according to claim 30, wherein the application server is an Internet Protocol (IP) Multimedia Service Switching Function (IP-SSF).

41. The IP multimedia subsystem according to claim 30, wherein the application server is an Open Service Access (OSA) Service Capability Server (SCS).

42. The IP multimedia subsystem according to claim 30, wherein the application server is triggered depending on a session state/user state.

43. The IP multimedia subsystem according to claim 30, wherein the stFC is compatible with 3GPP standard.

44. The IP multimedia subsystem according to claim 43, wherein the SIP server selectively disables the stFC.
